(19) United States
(12) Patent Application Publication
(10) Pub. No.: US 2021/0286203 A1
(43) Pub. Date: Sep. 16, 2021

(54) METHOD OF FABRICATING AN ELECTRO-OPTICAL DEVICE

(71) Applicant: IMEC USA NANOELECTRONICS DESIGN CENTER,INC., Kissimmee, FL (US)

(72) Inventor: Reza SAFIAN, Orlando, FL (US)

(21) Appl. No.: 16/817,548

(22) Filed: Mar. 12, 2020

(51) Int. Cl. G02F 1/035; H01P 3/00; H01P 11/00; G02F 1/225

(52) U.S. Cl. CPC G02F 1/0356; H01P 3/003; G02F 2001/212; G02F 1/2255; G02F 2202/20; H01P 11/001

(57) ABSTRACT

A method of fabricating an electro-optical device is provided. The method comprises providing a silicon-on-insulator (SOI) wafer comprising a silicon layer, a silicon oxide layer and at least one RF (radio frequency) electrode, wherein the at least one RF electrode is arranged inside the upper portion of the silicon oxide layer of the SOI wafer and providing a second substrate having a top structure of a RF (radio frequency) modulating material. The method further comprises bonding the second substrate on top of the SOI wafer such that said top structure of a RF (radio frequency) modulating material is arranged over the at least one RF electrode. Also, an electro-optical device is provided.

### TECHNICAL FIELD

The present inventive concept relates to the field of fabrication of electro-optical devices. More particularly it relates to a method of fabricating an electro-optical modulator for modulating electromagnetic waves in a radiofrequency (RF) waveguide.

### BACKGROUND

Both long-haul and short-distance network interconnects for conventional data networks and intra-/interchip data links continue to scale in complexity and bandwidth. As interconnect densities rise, the limitations of copper as an interconnect medium in terms of its loss, dispersion, crosstalk and fundamental speed becomes more eminent. Thus, the optical interconnect, with silicon photonics, with an optical medium of silicon, emerging as a leading approach because of its unique combination of low fabrication costs and performance enhancements. Electronic-photonic integration and compatibility with the world's most successful technology for producing electronics, CMOS, makes integrated photonic circuits more appealing.

One of the essential components of any communication link is the modulator. An optical modulator is a device that modulates a light beam propagating either in free space or in an optical waveguide. Based on the beam parameter these devices affect, they are categorized as either amplitude, phase or polarization modulators.

Applying an electric field to a material changes its real and imaginary refractive indices. A change in the real part of the refractive index with an applied electric field is known as electro-refraction effect and a change in the imaginary part of the refractive index is known as electro-absorption effect. Pockels effect, Kerr effect and the Franz-Keldysh effect are the physical phenomena which generate the refractive index change. Unfortunately, these effects are weak in pure silicon at the telecommunications wavelengths (1.3 to 1.55 μm). One of the alternative methods to achieve modulation in silicon is thermal modulation owing to the large thermo-optic coefficient of silicon. But this is too slow for the high frequencies required by modem telecommunications applications.

Lithium niobate (LN) electro-optical modulators are widely available as packaged commercial components from several suppliers, and there has been tremendous progress on large bandwidth, low power integrated lithium niobate modulators in recent years. All these interesting results are from different university research groups. The next phase would be mass production of these modulators using the foundry technologies. The problem with current state of the art designs is that none of them are fully compatible with conventional fabrication processes for producing electro-optical devices. Therefore, there is a need in the art for methods of fabricating electro-optical devices that are compatible with conventional mass-production processes for microelectromechanical systems (MEMS), i.e. compatible with standard processes and foundries for MEMS.

### SUMMARY

It is an object of the invention to at least partly overcome one or more limitations of the prior art. In particular, it is an object to provide a method of fabricating an electro-optical modulator for modulating electromagnetic waves in a radiofrequency (RF) waveguide.

It is a further object of the present invention to provide at least one method for large-scale, batch, or other foundry-level fabrication of an electro-optical device that are compatible with conventional mass-production processes for microelectromechanical systems (MEMS), i.e. compatible with standard processes and foundries for MEMS.

As used herein, the term vertical denotes a direction being parallel to a vertical geometrical axis extending perpendicular to the substrate, i.e. the SOI wafer. The terms “above”, “below”, “upper” and “lower” are thus used to refer to relative positions along the vertical axis. In addition, the term lateral or horizontal refers to the direction perpendicular to the vertical direction, i.e. to the direction parallel to the substrate surface.

Further, herein the abbreviation “RF” refers to radio-frequency (unless otherwise indicated).

As a first aspect of the invention, there is provided a method of fabricating an electro-optical device, comprising
a) providing a silicon-on-insulator (SOI) wafer comprising a silicon layer, a silicon oxide layer and at least one RF (radio frequency) electrode, wherein the at least one RF electrode is arranged inside the upper portion of the silicon oxide layer of the SOI wafer,
b) providing a second substrate having a top structure of a RF (radio frequency) modulating material; and
c) bonding the second substrate on top of the SOI wafer such that the top structure of a RF (radio frequency) modulating material is arranged over the at least one RF electrode.

The electro-optical device, for example, may be an electro-optical modulator. An electro-optical modulator is a device that can be used to control the power (amplitude), phase (delay), or polarization of an optical beam with an electrical signal. As an example, the electro-optical modulator may be configured such that the desired modulation is performed by changing optical parameters such as refractive index and absorption of the waveguide according to the modulating signal.

The electro-optic modulator may be a traveling wave modulator, in which an RF signal is used to modulate an optical signal.

At least one RF electrode is provided in the upper portion oxide layer of the SOI wafer, such in the silicon dioxide layer of the SOI wafer. Thus, the at least one RF electrode is provided closer to the upper surface of the oxide layer than to the lower surface.

Each of the RF electrodes may be a metallic strip. The metallic strip may function as an RF electrode. As an example, the electro-optical device may comprise several RF electrodes, such as at least three RF electrodes.

The RF electrodes may be spaced such that they together form an RF waveguide, such as a coplanar waveguide (CPW).

The SOI wafer is a layered silicon-insulator-silicon substrate commonly used in the fabrication of silicon semiconductor devices. The oxide layer of the SOI wafer may be the uppermost layer of the SOI wafer.

A first aspect of the present invention is based on the insight that fabricating the RF electrodes within the oxide layer of the SOI wafer minimizes the post processing needed after the foundry fabrication of the electro-optical device. In prior art devices, the RF electrodes are placed on top of the modulating layer, e.g. on top of a lithium niobate layer. In the method of the first aspect, the RF electrodes are fabricated in the oxide layer of the SOI wafer. After that, the modulating structure with its substrates is bonded to the SOI wafer using either direct or indirect bonding. Consequently, in the design of the present disclosure, the RF electrodes are inserted in e.g. the SiO₂ layer of the SOI wafer, which is thus below the modulating structure. The method of the present disclosure provides a fabrication process that is completely foundry compatible except for the bonding of the second substrate on top of the SOI wafer, which may be a back end of the line process that is performed outside the foundry.

The SOI wafer may comprise at least two RF electrodes, such as at least three RF electrodes.

The RF electrode may for example be metal tubes or pipes through which electromagnetic waves are propagated in microwave and RF communications. The wave passing through the medium may thus be forced to follow the path determined by the physical structure of the guide. As an alternative, the RF electrode components may, under certain conditions, contain a solid or gaseous dielectric material.

The RF electrodes may be made from aluminium (Al), chromium (Cr), gold (Au), brass (CuZn), bronze (CuSn), copper (Cu), or silver (Ag), for example All RF electrodes of the electro-optical device may be of the same material or of different materials.

In embodiments of the first aspect, the RF electrode comprises at least one metal selected from the group comprising gold (Au), chromium (Cr) and aluminium (Al). As an example, an RF electrode may comprise a mix of materials, such as both chromium (Cr) and gold (Au).

The RF electrode may be arranged in the uppermost portion of the oxide layer. In embodiments of the first aspect, the at least one RF electrode is arranged within the silicon oxide layer such that it forms part of the upper surface of the silicon oxide layer of the SOI wafer.

Thus, the second substrate may be bonded directly or indirectly to the oxide layer of the SOI wafer, and the RF electrodes may form part of this uppermost layer of the SOI wafer provided in step a), described below.

The second substrate has a top structure of an RF modulating material. The top structure may be formed as the uppermost layer of the second substrate. However, there may also be a further layer above the RF modulating material of the second substrate, such as a layer that facilitates bonding to the SOI wafer.

As an example, the top structure may be a layer, such as a top layer, of an RF modulating material as is well understood in this art.

In embodiments of the first aspect, the RF modulating material is selected from the group comprising of lithium niobate and barium tatanate.

Lithium niobate, or LN (LiNbO₃) is intrinsically a birefringent crystal that is widely used in electro optic devices. Barium tatanate, or BTO (BaTiO₃) provides a strong electro-optical effect.

Thus, the electro-optical device may be a thin film lithium niobate traveling wave modulator.

However, the RF modulating material may also be PZT (Lead zirconate titanate).

As an example, the top structure may be a top functional layer of a 300-900 nm LN (LiBNO₃) film. Such a film may be optionally doped with magnesium oxide (MgO).

In embodiments of the first aspect, the SOI wafer further comprises at least one optical waveguide. The optical waveguide may be of silicon (Si). In the fabricated electro-optical device, at least some optical waveguides and the RF electrodes may be located on the same side (underneath) the structure of a RF modulating material. The optical waveguides may for example be arranged at lateral positions that are in between the lateral positions of the RF electrodes. The optical waveguides may be part of a common optical waveguide structure.

In embodiments of the first aspect, step a) further comprises
a1) providing a SOI wafer comprising a silicon layer and a silicon oxide layer;
a2) etching trenches in the silicon oxide layer at positions for the RF electrodes;
a3) filling the trenches with a RF material adapted for guiding RF electromagnetic waves.

The RF electrodes may be fabricated in a SOI wafer by etching trenches in the oxide layer of the SOI wafer at the location of the RF electrodes using standard silicon foundry processes, such as dry etch. The RF electrode may then be fabricated in the formed trenches.

Step (a1) may also comprise forming at least one optical waveguide on top of the silicon dioxide layer. Thus, the optical waveguides may be fabricated on the SOI wafer before etching and formation of the RF electrodes. This means that both optical waveguides and RF electrodes may be on the same side of the modulating material in the electro-optical device.

As a further example, step (a3) may comprise depositing a seed layer for the RF material in the trenches followed by electroplating the RF material; thereby filling the trenches with the RF material.

Consequently, the RF material may be grown by first depositing a seed layer, such as a gold (Au) layer, in the trenches before electroplating the RF material. This seed layer may for example be between 10-20 nm. It may be advantageous to use a seed layer if the RF material has low adhesion to the oxide layer of the SOI wafer. As an example, the RF material may be or comprise gold (Au), and it may then be useful to deposit a thin seed layer before electroplating the gold (Au) in the trenches.

Material that has been deposited outside the trenches may then be removed using CMP or similar processes.

In embodiments of the first aspect, the second substrate is bonded top side down to the SOI wafer in step (c).

The top structure of a RF modulating material may thus be bonded such that the top structure faces the SOI wafer.

Bonding of the second substrate on top of the SOI wafer may be performed using both indirect bonding and direct bonding.

Consequently, in embodiments of the first aspect, the bonding of the second substrate on top of the SOI wafer in step (c) is performed by indirect bonding.

In direct bonding may comprise first depositing an intermediate layer on the SOI wafer and/or second substrate, and then bonding the SOI wafer and the second substrate. As an example, the indirect bonding may be adhesive bonding, (or glue bonding) which may comprise depositing an organic or inorganic layer, such as SU-8 or benzocyclobutene (BCB), on one or both of the SOI wafer and the second substrate.

Thus, as an example, step (c) comprises depositing a polymer layer on top of the SOI wafer and bonding the second substrate top side down on top of the polymer. Such a polymer may be a benzocyclobutene (BCB) based polymer.

However, in embodiments of the first aspect, the bonding of the second substrate on top of the SOI wafer in step (c) is performed by direct bonding.

A direct bonding may lead to chemical bonds between the second substrate and the outer surface of the SOI wafer. Such a direct bonding may be realized by using a planarized silicon oxide layer between the SOI wafer and the second substrate.

As an example, the silicon oxide layer may be deposited on the SOI wafer before bonding to the second substrate.

The second substrate may be bonded to the SOI wafer such that portions of the at least one RF electrode is not covered by the second substrate. These uncovered portions may be used for applying an RF signal to the RF electrodes. As an alternative, the second substrate may be bonded such that it fully covers some or all of the RF electrodes, and contacts to the RF electrodes may be formed in a later processing step.

In embodiments of the first aspect, all method steps except the except for the bonding of the second substrate on top of the SOI wafer, are performed in the same foundry line process. Bonding of the second substrate to the SOI wafer may then be performed using a back end of the line process that is performed outside the foundry.

According to a second aspect of the present inventive concept, there is provided an electro-optical device comprising:
a silicon layer, a silicon oxide layer and at least one RF (radio frequency) electrode arranged within the upper portion of the silicon oxide layer;
a structure of a RF (radio frequency) modulating material arranged in a layer over the silicon oxide layer for modulating electromagnetic waves propagating in the at least one RF electrode; and
wherein the electro-optical device comprises an intermediate layer between the silicon oxide layer and the structure of a RF modulating material.

This second aspect may generally present the same or corresponding advantages as the first aspect. Effects and features of this aspect are largely analogous to those described above in connection with the first aspect. Embodiments mentioned in relation to the first aspect are largely compatible with this aspect.

This aspect thus relates to an actual electro-optical device, such as an electro-optical modulator, which for example may be fabricated using the method of the first aspect discussed above. Thus, in embodiments, the electro-optical device is an electro-optical modulator.

The silicon layer may be the bottom layer of the device, and the silicon oxide layer may be arranged on top of the silicon layer.

In the device, the RF modulating material may be selected from the group comprising lithium niobate and barium tatanate.

Furthermore, the intermediate layer may be a polymer layer, such as a benzocyclobutene (BCB) based polymer layer. Such a layer may have been used when bonding a wafer comprising the RF modulating material to an SOI wafer comprising a silicon layer, a silicon oxide layer and at least one RF (radio frequency) electrode arranged within the upper portion of the silicon oxide layer.

However, as discussed in relation to the method above, the intermediate layer may be a silicon oxide layer, e.g. used in a direct bonding process.

In embodiments, the device further comprises at least one optical waveguide. Such an optical waveguide or waveguides may be arranged between the at least one RF electrode and the structure of a RF modulating material.

Hence, the electro-optical modulator may be an integrated travelling wave Mach-Zender modulator in which the RF electrodes are fabricated on the same layer as the optical waveguides, such that the RF electrodes and the optical waveguides are both arranged underneath the RF modulating structure.

Moreover, the RF electrode may comprise a material selected from the group comprising gold (Au), chromium (Cr) and aluminium (AI).

Further, the electro-optical device may comprise contacts arranged for applying an RF signal to the RF electrodes. The contacts may for example be arranged at portions of the RF electrodes that are not covered by the second substrate.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 illustrates an electro-optical device.

FIGS. 2a-2h illustrate a method for fabricating an electro-optical device.

FIGS. 3a and 3b illustrate an embodiment for boning the second substrate to the SOI wafer.

FIG. 4 is a perspective view of an electro-optical modulator.

FIG. 5 show the general process steps in the method for fabricating an electro-optical device.

### DETAILED DESCRIPTION

In the above disclosure the inventive concept has mainly been described with reference to a limited number of examples. However, as is readily appreciated by a person skilled in the art, other examples than the ones disclosed above are equally possible within the scope of the inventive concept, as defined by the appended claims.

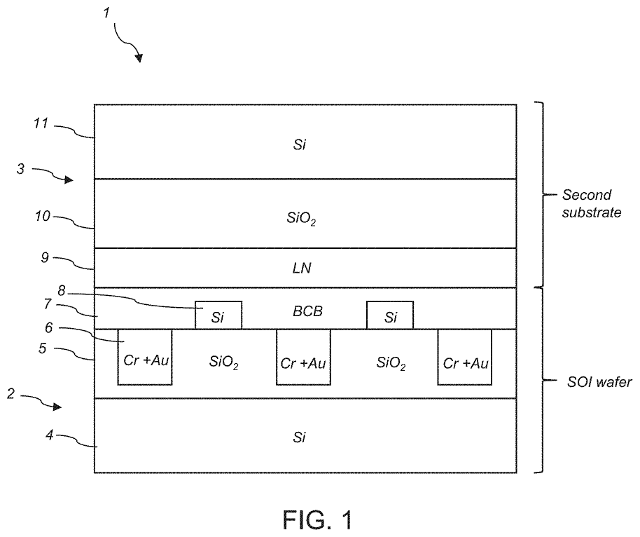

FIG. 1 (FIG. 1) is a schematic illustration of a cross-section of an electro-optical device of the present disclosure in the form of an electro-optical modulator 1. The modulator 1 comprises a silicon layer 4 as a bottom layer, a silicon dioxide layer 5 on top of the silicon layer 4. There are three RF (radio frequency) electrodes 6 arranged within silicon dioxide layer 5, in this case in the uppermost portion of the silicon dioxide layer 5. There are in this embodiment three RF electrodes in the form of three strips of chromium (Cr) and gold (Au).

Moreover, there are two optical waveguides 8 arranged on top of the silicon dioxide layer 5, but at different locations than the RF electrodes 6.

There is also a structure of a RF (radio frequency) modulating material 9, in the form of a layer of lithium niobate (LiNbO₃, also abbreviated as “LN”) arranged in a layer over the silicon dioxide layer 7. This structure or layer 9 is arranged at a distance from the RF electrodes 6 such that it provides for modulating the electromagnetic waves propagating in the RF electrodes, e.g. by a change in the strength of the local electric field. Thus, the electro-optical device 1 may comprise control means for controlling the electric field at the position of the LN (LiBNO₃) layer 9.

In the electro optic device of FIG. 1 both the optical waveguides and the RF electrodes are positioned under the RF modulating material. As further illustrated in FIG. 1, there is an intermediate layer 7 arranged between the silicon dioxide layer 5 and the LN (LiBNO₃) layer 9. In this example, this is in the form of a polymer layer of benzocyclobutene (BCB) or a BCG based polymer, which has been used during wafer bonding of an SOI wafer 2 with a second substrate 3. Thus, the device 1 as illustrated in FIG. 1 has been fabricated by bonding a second substrate top-side down to a SOI wafer. The second substrate is a substrate comprising silicon 11, a silicon oxide layer on top of the silicon 11 and a top layer of LN (LiBNO₃) that has been bonded top-side down to the SOI wafer 2 using the BCB-layer as an intermediate layer.

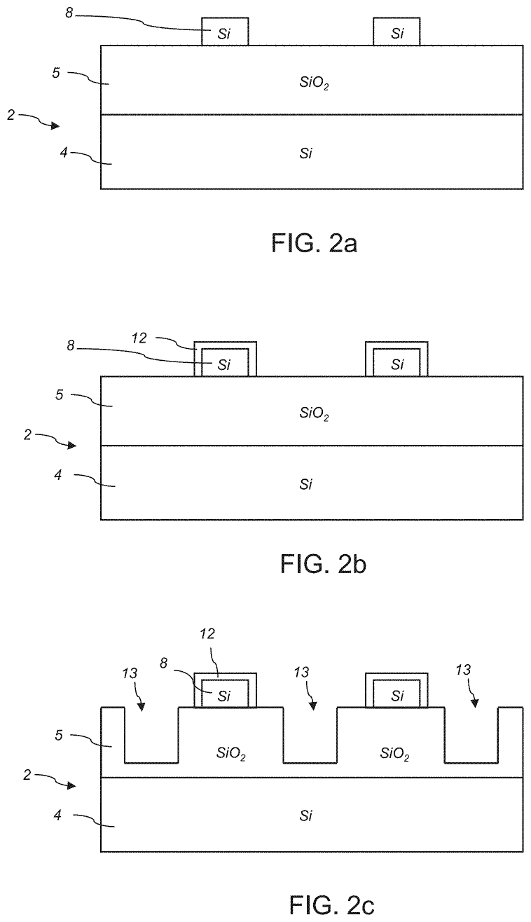

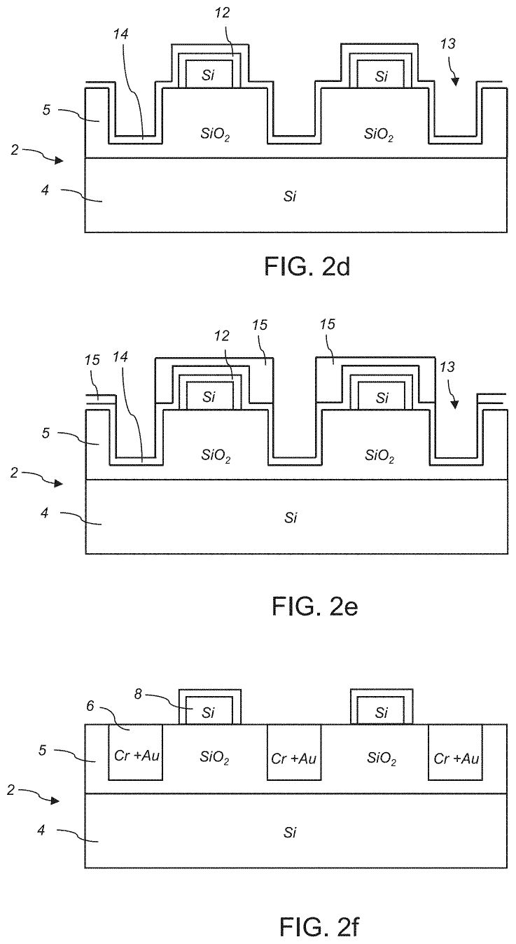

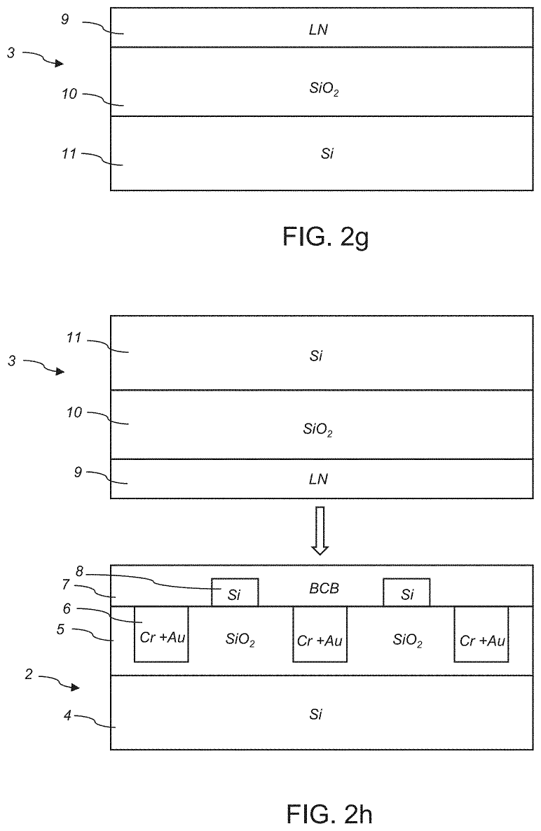

FIGS. 2a-h further illustrates a fabrication process for fabricating an electro-optical device according to the present disclosure.

As illustrated in FIG. 2a, optical waveguides 8 are fabricated using a standard foundry fabrication process on a SOI (Silicon-on-insulator) wafer 2. SOI wafers are commercially available and comprises a thin silicon layer (device layer) on top of a thick silicon dioxide layer 5 (insulator layer, BOX) on a silicon substrate 4. Here, SOI wafers 2 with 220 nm thickness of device layer may be used for optical waveguide fabrication, and the optical waveguides 8 may be fabricated in the device layer by standard silicon-foundry processing which includes lithography (ultraviolet (UV) or electron-beam (e-beam)), photoresist development, dry etching and photoresist removal.

As illustrated in FIG. 2b the optical waveguides 8 may then be covered by a thin layer of silicon dioxide (50 to 100 nm) for protection. This can be done by using plasma-enhanced chemical deposition (PECVD) system.

Thereafter, as illustrated in FIG. 2b, the silicon dioxide layer 5 of the SOI wafer 2 is etched using standard silicon foundry processes such as dry etch, at the location of radiofrequency (RF) waveguides (electrodes), thereby creating trenches 13 in the silicon dioxide layer 5 at the location of the RF electrodes. Since the RF electrodes should be as thick as possible and it should not contact with the silicon substrate, the box layer is etched until 100 to 150 nm to the silicon layer underneath.

As illustrated in FIG. 2d, a thin seed layer 14, such as a thin gold (Au) layer 14, may be needed in order to fabricate the RF electrodes in the trenches 13. Because of normally low adhesion quality of e.g. gold to silicon or silicon dioxide layers, first a thin adhesion layer (not shown) may thus be necessary, e.g. having a thickness of 10 to 20 nm. Chromium (Cr), titanium (Ti) and nickel (Ni) are good adhesion layers, and they can be deposited by using electron-beam or thermal evaporation systems. Then, 50 to 100 nm of gold (Au) is deposited (using the same standard processes) on top of the adhesion layer. The resultant layer (adhesion+gold (Au)) which is normally around 100 to 150 nm is called the seed layer 14. The seed layer 14 will facilitate the electro-plating process further on in the fabrication process for forming the RF electrodes.

Then, as illustrated in FIG. 2e, the surface of the SOI wafer 2, except for the trenches 13 where the RF electrodes will be formed, is covered by a silicon dioxide layer 15 (same as in the previous steps), or e.g. a photoresist, in order to prevent deposition in the subsequent electroplating process outside the trenches 13.

During the electroplating process, trenches 13 are thus filled with a RF material, such as gold (Au) and or chromium (Cr), thereby forming the RF electrodes 6. Electro-plating is a standard process that uses an electric current to reduce dissolved metal cations so that they form a thin coherent metal coating on e.g. an electrode (or in this case within the trenches 13). Electro-plating process is in this example used to form thick RF electrodes of e.g. gold (Au) in the order of few (1-2) micrometres.

Oxide 15 and any RF material outside the trenches 13 are removed by standard dry or wet etching techniques. The formed structure is illustrated FIG. 2f. Thus, FIGS. 2a-2f illustrate providing a silicon-on-insulator (SOI) wafer comprising a silicon layer, a silicon oxide layer and at least one RF (radio frequency) electrode, wherein the at least one RF electrode is arranged inside the upper portion of the silicon oxide layer of the SOI wafer, by performing the steps of
a1) Providing a SOI wafer comprising a silicon layer and a silicon oxide layer;
a2) etching trenches in the silicon oxide layer at positions for the RF electrodes; and
a3) filling the trenches with a RF material adapted for guiding RF electromagnetic waves.

Finally, only the active part of the SOI wafer 2 should be covered by an RF modulating material such as lithium niobate (LiBNO₃, LN). The active parts include the parts where the RF electrodes 6 are positioned. For this purpose, a second substrate 3 in the form of a LN (LiBNO₃) wafer is provided. Such a wafer 3 is schematically illustrated in FIG. 2g. The wafer 3 may have a bottom substrate layer 11 of e.g. Si, LN, quartz or fused silica, and may have a thickness of 400-500 μm. On top of the substrate layer 11, there is an isolation layer 10, such as a SiO₂ layer with a thickness of 1000-4000 nm. The top functional layer 9 is of lithium niobate (LiBNO₃, or LN). This layer may have a thickness of 300-900 nm and may optionally be doped with MgO. Thus, FIG. 2g illustrate the step of providing a second substrate having a top structure of a RF (radio frequency) modulating material.

The whole second substrate 3, or pieces of it, may then be bonded to the SOI wafer 2 such that the top functional layer 9 is arranged vertically above the RF electrodes 6. Thus, the whole SOI wafer does not have to be covered with the second substrate 3. Further, not all parts of the RF electrodes 6 may be covered by the second substrate 3. Uncovered portions may be used for applying an RF signal to the RF electrodes 6, e.g. by forming contacts to such uncovered portions.

The second substrate 3 may be bonded top-side down to the fabricated SOI wafer 2, as illustrated in FIG. 2h. The bonding may be performed by using BCB (benzo-cyclo-butene) polymer. A BCB solution may be spun on the SOI wafer 2 before bonding to form a layer 7 of BCB on the SOI wafer 2. Alternatively, the BCB solution may be spun onto the LN (LiBNOs) layer 9 of the second substrate 3 Then, the second substrate 3 is bonded such that the LN layer is arranged vertically above the RF electrodes 6, such that they may be used to modulate an electromagnetic wave propagating in the RF electrode. After attachment of the second substrate 3 top side down on the BCB layer 7 of the SOI wafer 2, the whole structure may through standard thermal process in order to cure the BCB layer. At the same time, external mechanical force may be applied in order to bond the layers together. Consequently, FIG. 2h illustrate the step of bonding the second substrate on top of the SOI wafer such that the top structure of a RF (radio frequency) modulating material is arranged over the at least one RF electrode.

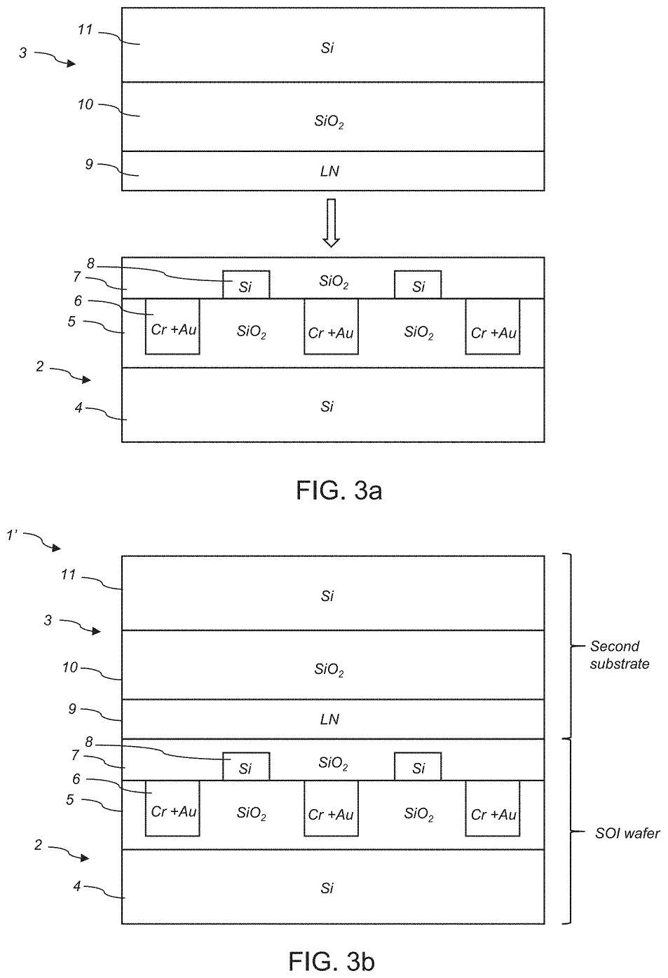

However, the second substrate 3, i.e. the LN (LiBNO₃) wafer, may be bonded by other means than using a BCB (benzo-cyclo-butene) layer to the first substrate 2. As an example, an SiO₂ layer may be deposited on top of a first substrate 2 that has been manufactured as illustrated in FIGS. 2a-2f before a LN (LiBNOs) wafer 3 is bonded top side down onto the first substrate 2, as illustrated in FIG. 3a. This would give an electro-optical device 1′ as illustrated in FIG. 3b. In this device 1′, parts of the thin film lithium niobate 9 may be etched to have access to the RF electrodes 6.

Consequently, the bonding of the second substrate 3 on top of the SOI wafer 2 may be performed by different methods, as summarized below:
i) The second substrate 3 may be in the form of one or several chips that are bonded onto the SOI wafer 2 using polymer bonding. Thus, the second substrate 3 may be in the form of one or several thin film lithium niobate (TFLN) chips comprising a thin film lithium niobate layer over a SiO₂ layer+a Si layer that are bonded on top of the SOI wafer 2 using a polymer such as BCB (benzo-cyclo-butene) as an adhesive
ii) The second substrate 3 may be in the form of one or several chips that are bonded directly onto the SOI wafer 2. The SOI wafer 2 may be planarized before bonding the second substrate 3. Thus, the second substrate 3 may be in the form of one or several thin film lithium niobate (TFLN) chips comprising a thin film lithium niobate layer over a SiO₂ layer+a Si layer that are directly bonded on top of the SOI wafer 2.
iii) The second substrate 3 may be in the form of a thin film lithium niobate (TFLN) wafer comprising a thin film lithium niobate layer over a SiO₂ layer+a Si layer. This wafer 3 may be directly bonded onto the SOI wafer 2. Parts of the TFLN wafer 3 which is arranged on top suitable access points for the RF signal after bonding may later be etched to form contacts.
iv) The second substrate 3 may be in the form of a bulk lithium niobate (LN, LiBNOs) wafer that is directly bonded on top of the SOI wafer 2. The SOI wafer 2 may be planarized before bonding and the bulk lithium niobate wafer may be cut using e.g. ion implantation methods such that the thin film lithium niobate is arranged on top of the SOI wafer 2. Parts of the lithium niobate (LN, LiBNO₃) which is arranged on top of the RF probes may also later be etched.

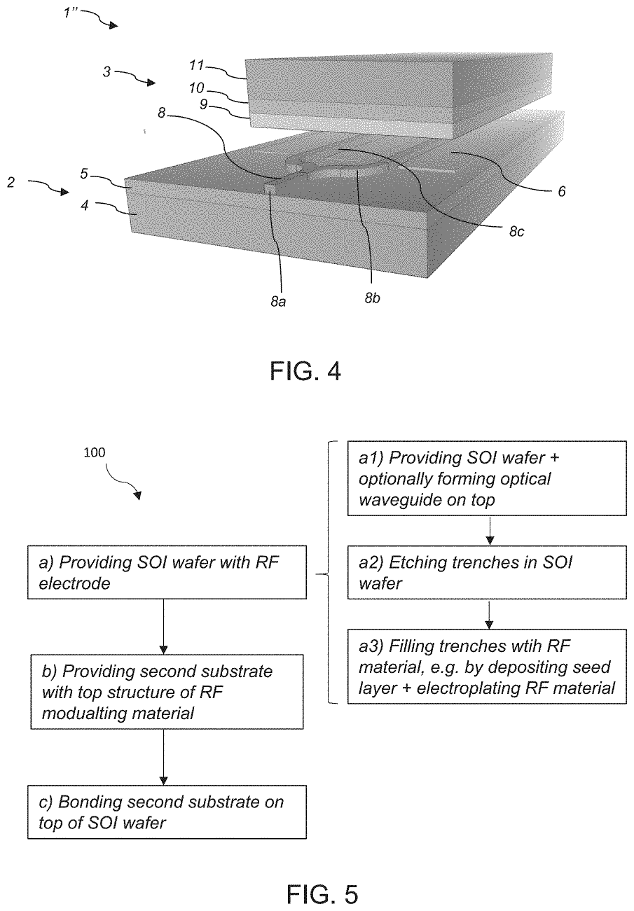

FIG. 4 is a schematic perspective view of an electro-optical modulator 1″ in the form of thin film lithium niobate Mach-Zehnder traveling wave modulator. This may be used for modulating or controlling, for example, the phase or amplitude of an optical wave travelling in the optical waveguide 8. As illustrated in FIG. 4, the optical waveguide 8 is split into two waveguide arms 8b and 8c before passing the position of the RF electrodes 6. Thus, the input portion 8a of the optical waveguide 8 may be configured for receiving an electromagnetic wave and e.g. be arranged for being connected to a laser source (not shown).

As further seen in FIG. 4, the LN (LiBNO₃) substrate 3 is arranged and bonded over the SOI wafer 2 such that it covers the middle portion of the SOI wafer 2, i.e. arranged over the RF electrodes 6. The three RF electrodes 6 have a spacing such that they together form an RF waveguide, in this case a coplanar waveguide (CPW) structure. After passing through the position of the RF electrodes 6, the waveguide arms 8b and 8c are recombined into one waveguide.

The two ends of the RF electrodes 8 are not covered by the LN (LiBNOs) wafer 3, and they may be used for applying an RF signal. When an RF signal is applied over the electrodes 6, a phase shift may be induced for the electromagnetic wave passing through the waveguide arms 8b and 8c and when the two arms 8b and 8c are recombined, the phase difference between the two waves is converted to an amplitude modulation. Thus, unmodulated optical signal is fed into the optical waveguide 8 from one side 8a and modulated optical signal is extracted from the other end of the optical waveguide 8.

FIG. 5 schematically illustrates the method for fabricating an electro-optical device according to the present disclosure. The method comprises the overall process steps of a) providing a silicon-on-insulator (SOI) wafer comprising a silicon layer, a silicon oxide layer and at least one RF (radio frequency) electrode, wherein the at least one RF electrode is arranged inside the upper portion of the silicon oxide layer of the SOI wafer. The method further comprises a step b) of providing a second substrate having a top structure of a RF (radio frequency) modulating material and a step c) of bonding the second substrate on top of the SOI wafer such that the top structure of a RF (radio frequency) modulating material is arranged over the at least one RF electrode. Step a) of providing the SOI wafer with at least one RF electrode may comprise the substep a1) of providing a SOI wafer comprising a silicon layer and a silicon oxide layer. This step a1 may also include forming optical waveguide or waveguides on top of the silicon dioxide layer. Step a) may further comprise the substeps a2) of etching trenches in the silicon oxide layer at positions for the RF electrodes and a3) of filling the trenches with a RF material adapted for guiding RF electromagnetic waves. Step a) may include depositing a seed layer for the RF material in the trenches followed by electroplating the RF material; thereby filling the trenches with the RF material.

In the above, the inventive concept has mainly been described with reference to a limited number of examples. However, as is readily appreciated by a person skilled in the art, other examples than the ones disclosed above are equally possible within the scope of the inventive concept, as defined by the appended claims.

1. A method of fabricating an electro-optical device, comprising
a) providing a silicon-on-insulator (SOI) wafer comprising a silicon layer, a silicon oxide layer and at least one RF (radio frequency) electrode, wherein the at least one RF electrode is arranged inside the upper portion of the silicon oxide layer of the SOI wafer,
b) providing a second substrate having a top structure of a RF (radio frequency) modulating material; and
c) bonding the second substrate on top of the SOI wafer such that said top structure of a RF (radio frequency) modulating material is arranged over the at least one RF electrode.

2. The method according to claim 1, wherein the at least one RF electrode is arranged within the silicon oxide layer such that it forms part of the upper surface of the silicon oxide layer of the SOI wafer.

3. The method according to claim 1, wherein the RF modulating material is selected from the group comprising of lithium niobate and barium tatanate.

4. The method according to claim 1, wherein the RF electrode comprises at least one metal selected from the group comprising gold (Au), chromium (Cr) and aluminium (Al).

5. The method according to claim 1, wherein the SOI wafer further comprises at least one optical waveguide.

6. The method according to claim 1, wherein step (a) further comprises
(a1) providing a SOI wafer comprising a silicon layer and a silicon oxide layer;
(a2) etching trenches in the silicon oxide layer at positions for the RF electrodes;
(a3) filling the trenches with a RF material adapted for guiding RF electromagnetic waves.

7. The method according to claim 6, wherein step (a1) further comprises forming at least one optical waveguide on top of said silicon dioxide layer.

8. The method according to claim 6, wherein step (a3) comprises depositing a seed layer for the RF material in the trenches followed by electroplating the RF material; thereby filling the trenches with said RF material.

9. The method according to claim 1, wherein the second substrate is bonded top side down to the SOI wafer in step (c).

10. The method according to claim 1, wherein the bonding of the second substrate on top of the SOI wafer in step (c) is performed by indirect bonding.

11. The method according to claim 10, wherein step (c) further comprises depositing a polymer layer on top of the SOI wafer and bonding the second substrate top side down on top of the polymer.

12. The method according to claim 11, wherein the polymer is a benzocyclobutene (BCB) based polymer.

13. The method according to claim 1, wherein the bonding of the second substrate on top of the SOI wafer in step c) is performed by direct bonding.

14. The method according to claim 13, wherein the direct bonding is performed with a planarized silicon oxide layer between the SOI wafer and the second substrate.

15. The method according to claim 1, wherein the electro-optical device is an electro-optical modulator.

16. An electro-optical device comprising:
a silicon layer, a silicon oxide layer and at least one RF (radio frequency) electrode arranged within the upper portion of the silicon oxide layer;
a structure of a RF (radio frequency) modulating material arranged in a layer over the silicon oxide layer for modulating electromagnetic waves propagating in said at least one RF electrode; and
wherein the electro-optical device comprises an intermediate layer between the silicon oxide layer and the structure of a RF modulating material.

17. The electro-optical device according to claim 16, wherein the RF modulating material is selected from the group comprising lithium niobate and barium tatanate.

18. The electro-optical device according to claim 16, wherein the intermediate layer is a polymer layer.

19. The electro-optical device according to claim 18, wherein the polymer of the polymer layer is a benzocyclobutene (BCB) based polymer.

20. The electro-optical device according to claim 16, wherein the intermediate layer is a silicon oxide layer.
